(19) United States
(12) Patent Application Publication
(10) Pub. No.: US 2026/0241872 A1
(43) Pub. Date: Aug. 20, 2026

(54) HOLDER FOR PORTABLE DEVICE

(71) Applicant: iOttie Inc., Fort Lee, NJ (US)

(72) Inventor: Inhwan CHO, Leonia, NJ (US)

(73) Assignee: iOttie Inc., Fort Lee, NJ (US)

(21) Appl. No.: 19/543,755

(22) Filed: Feb. 18, 2026

Related U.S. Application Data
(60) Provisional application No. 63/760,308, filed on Feb. 19, 2025.

(51) Int. Cl. B60R 11/02; B60R 11/00

(52) U.S. Cl. CPC B60R 11/0241; B60R 2011/0003

(57) ABSTRACT

The present disclosure relates to a holder for a portable device containing: a main body for holding a portable device received on a front surface portion thereof; a first switch formed at a designated position of the front surface portion of the main body; a first and a second arm formed at left and right sides of the surface portion of the main body; and a second switch comprising: a first button to be physically connected to the first arm inside the main body; a second button to be physically connected to the second arm inside the main body, and varying the distance between the first and second arms; and a disk or a rotating part connected to the first and the second arms and the first and the second buttons.

### CROSS-REFERENCE TO RELATED APPLICATIONS

This application claims the benefit of priority from U.S. Provisional Patent Application No. 63/760,308, filed Feb. 19, 2025 and entitled “HOLDER FOR PORTABLE DEVICE”, the entire contents of which are incorporated herein by reference.

### FIELD OF TECHNOLOGY

The present disclosure relates to a holding mechanism, and more particularly, to a holder for a portable device.

### BACKGROUND

A personal portable device represented by a portable phone has become a necessity which is owned by each person. Various portable devices, such as vehicle navigators, multimedia players, portable broadcasting receivers and digital cameras/camcorders, as well as the portable phones are commonly used, and various accessory industries for portable devices are also developing together. In particular, a holder for holding a portable device is used for holding the portable device during driving or during study or business hours.

However, although portable devices made by different makers may provide the same or similar functions, the portable devices have different sizes from each other. Therefore, when a user replaces his/her portable phone with a different model, the user must replace a holder which was purchased for the portable phone. Therefore, when the usable holder is replaced, it may result in an unnecessary cost. Furthermore, when the usable holder is discarded, it is a waste of resources.

Furthermore, when a portable device is attached to or detached from an existing holder, a user must manipulate a plurality of buttons or apply a physical force, which may make the user feel uncomfortable. When a physical force is applied, an impact may be transmitted to the portable device. Thus, the operating mechanism of the holder is desirable to be simple.

### SUMMARY

An embodiment of the present disclosure is directed to a holder for mounting and detaching a portable device.

Another embodiment of the present disclosure is directed to a holder for stably holding a portable device using a simple structure.

According to an embodiment of the present disclosure, a holder (1) for a portable device comprises:
a main body (30) for holding a portable device received on a front surface portion (12) thereof;
a first switch (610) formed at a designated position of the front surface portion of the main body so as to be push into and protruded from the front surface portion;
a first and a second arm (410, 510) formed at left and right sides of the surface portion (12) of the main body (30) whose distance is controlled by the first switch (610) to hold or release the portable device; and
a second switch comprising:
a first button (420) to be physically connected to the first arm (410) inside the main body;
a second button (520) to be physically connected to the second arm (510) inside the main body (30), and varying the distance between the first and second arms (410, 510); and
a disk (803) or rotating part (803a) connected to the first and the second arms and the first and the second buttons,
wherein pushing the first button or the second button moves the first and the second arm to release the portable device.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a perspective view of a holder for a portable device according to one embodiment of the present disclosure.

FIG. 2 is a perspective view of a holder for a portable device according to another embodiment of the present disclosure.

FIG. 3 is an another portable holder of the present disclosure.

FIG. 4 is an exploded perspective view of a portable device holder.

FIG. 5 provides an assembled perspective view of the holder illustrated in FIG. 2.

FIG. 6 provides another assembled perspective view of the holder illustrated in FIG. 2.

FIG. 7 is a perspective view illustrating the rear surface of the holder to which a bracket is coupled.

FIG. 8 is a diagram for explaining a method for holding a mobile device using the holder.

FIG. 9 is another diagram for explaining a method for holding a mobile device using the holder.

FIG. 10 illustrates a mechanism of a portable device holder to open both arms by pushing both buttons.

FIG. 11 is an exploded view of an embodiment of the portable device holder 8 of the present disclosure having a disk 8.

FIG. 12 is an exploded view of another embodiment of the portable device holder 8A of the present disclosure having a rotating part 8a.

FIG. 13 is another exploded perspective view of a portable device holder of the present disclosure having a disk 8.

FIG. 14 illustrates a mechanism of a portable device holder of the present disclosure.

FIG. 15 illustrates another diagram showing the mechanism of a portable device holder of the present disclosure. A user can open both arms 2 with pushing only one button 1 to trigger the disk to rotate, wherein two disk holes push out pins to outward to open both arms. All steps are conducted in one step.

FIG. 16 provides a mechanism for closing both arms by pushing one switch. A user can close arms by pushing the button which trigger the inside arm holder to close two arms.

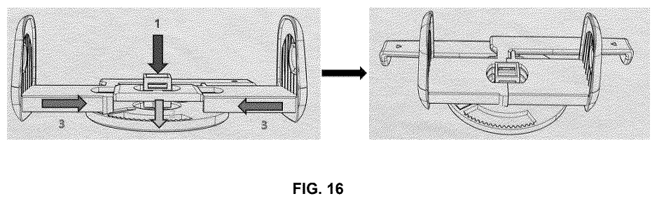

### DETAILED DESCRIPTION

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The portable device holder of the present disclosure provides a one touch mechanism to load the portable device onto the holder by one button, wherein the portable device can push the one button to close side arms to receive and hold the portable device.

Furthermore, the portable device holder of the present disclosure provides a mechanism wherein operating such as releasing the portable device from the holder is achieved by one push switch instead of two side switches as in the conventional mechanism.

This device is designed to assist users in mounting their mobile devices. It allows users to check their mobile devices while driving. The improved idea involves a one-touch method in the mobile device holder product, which makes it easier for users to mount their devices. Previously, the one-touch method required users to press both arms simultaneously to secure the device. This has been improved so that moving just one arm will cause both to move and secure the device. Now, users can hold the device in one hand and easily mount it.

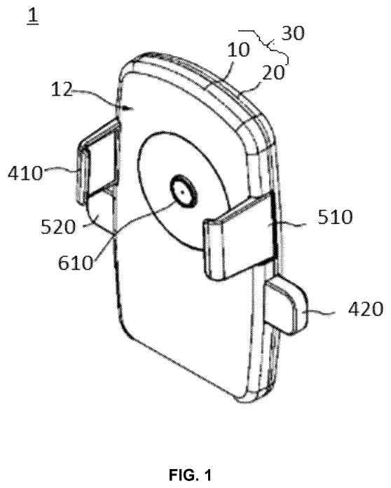

Referring to FIG. 1, the holder 1 according to the embodiment of the present disclosure includes a main body 30 having a front surface portion 12 on which a portable device is received. The main body 30 includes a front cover 10 and a rear cover 20, and optionally be formed to have substantially a rectangular cross-section or like when seen at the side of the front surface portion 12.

Furthermore, the main body 30 has a first switch 610 formed at a designated position of the front surface portion 12, and the first switch 610 protrudes to the outside of the front surface portion 12 from the inside of the main body 30. The first switch 610 may include a push switch, for example. The first switch 610 is pushed to the inside by a pressure which is applied when the portable device is held on the front surface portion 12. Furthermore, an operation of pulling the first switch 610 is performed by first and second buttons 420 and/or 520 which will be described below. The detailed descriptions of the operation will be made below.

Meanwhile, the main body 30 has first and second arms 410 and 510 formed at both side surfaces thereof. The first and second arms 410 and 510 have a distance from each other, which is varied by a push/pull operation of the first switch 610. When the first switch 610 is pushed to the inside of the main body 30, the distance between the first and second arms 410 and 510 is decreased toward the inside the main body such that the portable device is fixed on the front surface portion 12 by the first and second arms 410 and 510. Furthermore, when the first switch 610 is pulled from the main body 30 by a pressurizing operation of the first and/or second buttons 420 and 520 which will be described below, the distance between the first and second arms 410 and 510 is increased, so that the user may detach the portable device from the holder.

The first and second buttons 420 and 520 form a second switch. The first button 420 is physically connected to the first arm 410 inside the main body 30. Therefore, when the first arm 410 is moved to the inside of the main body 30, the first button 420 protrudes to the outside of the body 30. Similarly, when the second arm 510 is moved to the inside of the main body 30, the second button 520 protrudes to the outside of the main body 30.

In the holder 1 for a portable device, when the portable device is closely attached to the front surface portion 12, the first switch 610 is pushed to the inside of the main body 30. Accordingly, the distance between the first and second arms 410 and 510 is decreased to fix the portable device. At the same time, the first and second buttons 420 and 520 protrude to the outside. In this state, when the first and second buttons 420 and/or 520 are pressurized toward the inside of the main body 30, the distance between the first and second arms 410 and 510 is increased toward the outside of the main body 30, and the first switch 610 protrudes. Then, the user may detach the portable device from the holder 1.

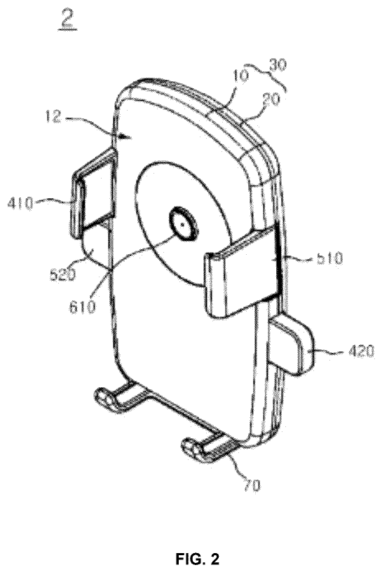

FIG. 2 is a perspective view of a holder 2 for a portable device according to another embodiment of the present disclosure. The holder 2 of another embodiment of the present disclosure further includes a bracket 70 in addition to the components of the holder 1 illustrated in FIG. 1. The bracket 70 is formed at the bottom of the main body 30 and serves to support a portable device such that the portable device does not come off from the holder 2. The bracket 70 is fixed to a rear surface portion of the main body 30 through a knob. The knob may be formed in a screw type, for example. The bracket 70 may be moved left and right and/or up and down in a state where the knob is released. Furthermore, the bracket 70 may be formed in such a shape that the central portion thereof is opened. Through the opened portion, an external connection cable of the portable device may be passed.

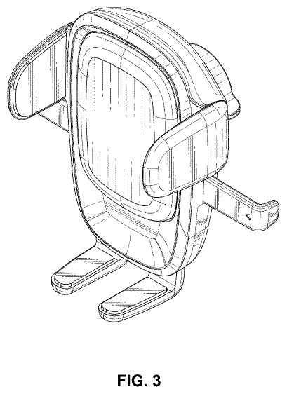

FIG. 3 is a perspective view of another holder 2a for a portable device according to another embodiment of the present disclosure. The first switch in the holder 2a has a square shape with round corners.

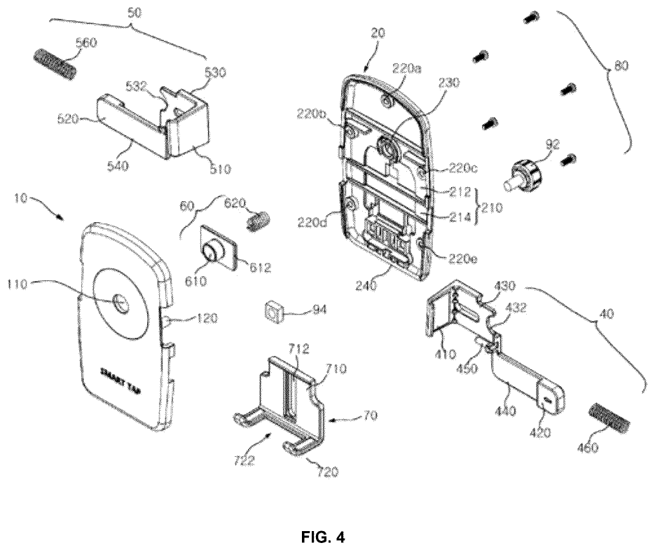

The structure of an exemplary holder 2 is described in more details in FIGS. 4-8.

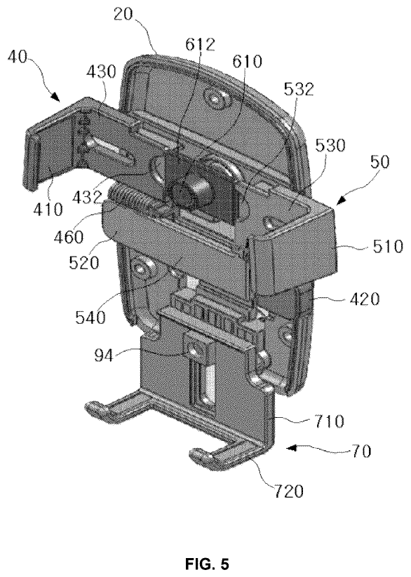

FIG. 4 is an exploded perspective view of the holder illustrated in FIG. 2, and FIGS. 4 and 5 are assembled perspective views of the holder illustrated in FIG. 2.

Referring to FIG. 4, the front cover 10 of the main body 30 includes a switch through-hole 110 through which the first switch 610 is pushed/pulled. Furthermore, the front cover 10 includes one or more coupling protrusions 120 formed at designated positions on a back surface of the front cover 10, that is, a surface contacted with the rear cover 20 such that the front and second covers 10 and 20 are coupled to each other through the coupling protrusions 120.

The rear cover 20 includes a housing unit 210 to house first and second attach/detach control units 40 and 50 and which will be described below. In particular, the housing unit 210 includes an upper housing unit 212 and a lower housing unit 214. Furthermore, the rear cover 20 includes coupling grooves 220a, 220b, 220c, 220d, and 220e formed at positions corresponding to the coupling protrusions 120 provided on the front cover 10. In a state where the front and rear covers 10 and 20 are coupled to each other after internal devices are assembled, the coupling grooves 220a, 220b, 220c, 220d, and 220e and the coupling protrusions 120 are fixed through screws 80. Furthermore, the rear cover 20 has a switch assembling hole 230 formed at a designated position thereof, or desirably, the central portion of the upper housing unit 212. Through the switch assembling hole 230, a switching unit 60 is coupled to the rear cover 20. Furthermore, the rear cover 20 has a hole 240 formed at the bottom thereof and coupled to a knob 92 for fixing or moving the bracket 70. The knob 92 forms a pair with a nut 94. Depending on the open or close state of the knob 92, the bracket 70 may be moved or fixed.

The first attach/detach control unit 40 includes a first arm 410, a first button 420, a first arm moving shaft 430, a first button moving shaft 440, and a first elastic shaft 450. The first arm 410 is pushed into and protruded from one side surface of the main body 30. The first button 420 is pushed into and protruded from the other side surface of the main body 30. The first arm moving shaft 430 provides a physical force to push/protrude the first arm 410. The first button moving shaft 440 provides a physical force to push/protrude the first button 420. The first elastic shaft 450 is coupled to a first elastic member 460.

Similarly, the second attach/detach control unit 50 includes a second arm 510, a second button 520, a second arm moving shaft 530, a second button moving shaft 540, and a second elastic shaft (not illustrated). The second arm 510 is pushed into and protruded from the other side surface of the main body 30. The second button 520 is pushed into and protruded from the one surface of the main body 30. The second arm moving shaft 530 provides a physical force to push/protrude the second arm 510. The second button moving shaft 540 provides a physical force to push/protrude the second button 520. The second elastic shaft is coupled to a second elastic member 560.

Here, the arm moving shafts 430 and 530 have one side extended perpendicular to the arms 410 and 510, and the button moving shafts 440 and 540 are extended in the same direction as the extension direction of the arm moving shafts 430 and 530 from positions spaced at a designated distance in a direction perpendicular to the extension direction of the arm moving shafts 430 and 530, respectively. One ends of the button moving shafts 440 and 540 serve as the buttons 420 and 520, respectively.

Furthermore, the elastic shafts 450 and 550 are formed to a designated length in the formation direction of the arm moving shafts 430 and 530 from the other ends of the button moving shafts 440 and 540, and coupled to the elastic members 460 and 560, respectively.

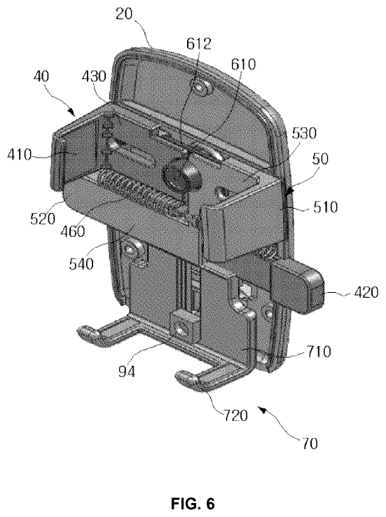

Referring to FIGS. 5 and 6, the first arm moving shaft 430 of the first attach/detach control unit 40 is housed in one side (for example, left side) of the upper housing unit 212, and the first button moving shaft 440 is housed in the other side (for example, right side) of the lower housing unit 213. Accordingly, the first arm 410 may be protruded from one side of the main body 30, and the first button 420 may be protruded from the other side of the main body 30. The second arm moving shaft 530 of the second attach/detach control unit 50 is housed in the other side of the upper housing unit 212, and the second button moving shaft 540 is housed in one side of the lower housing unit 214. Accordingly, the second arm 510 may be protruded from the other side of the main body 510, and the second button 520 may be protruded from the one side of the main body 30.

Meanwhile, the switching unit 60 includes a third elastic member 620 and the first switch 610 having a pressurization plate 612. The pressurization plate 612 serves to pressurize the third elastic member 620 through a rear surface portion thereof in a designated state. The first switch 610 is formed to protrude from a designated position on a front surface portion of the pressurization plate 612, for example, the center portion of the pressurization plate 612.

The first switch 610 including the third elastic member 620 and the pressurization plate 612 is assembled into the switch assembling hole 230. Furthermore, the first and second attach/detach control units 40 and 50 are assembled. In a state where the third elastic member 620 is not pressurized, the first switch 610 has a protruding shape, and the other sides of the first and second arm moving shafts 430 and 530 of the first and second attach/detach control units 40 and 50 are closely attached to both sides of the pressurization plate 612. At this time, the first and second elastic members 460 and 560 are compressed, the distance between the first and second arms 410 and 510 is increased toward the outside of the main body 30, and the first and second buttons 420 and 520 are pushed to the inside of the main body 30. When a physical force is applied to the first switch 610, the pressurization plate 612 compresses the third elastic member 620, and the first and second arms 410 and 510 are pushed to the inside of the main body 30 by restoring forces of the first and second elastic members 460 and 560. Meanwhile, the first and second buttons 420 and 520 are protruded to the outside of the main body 30. Furthermore, the switch coupling grooves 432 and 532 formed at the ends of the first and second arm moving shafts 430 and 530 are coupled to the first switch 610, thereby maintaining a state where the pressurization plate 612 pressurizes the third elastic member 620. Meanwhile, the bracket 70 is fixed to the hole 240 of the rear cover 20 through the knob 92 and the nut 94.

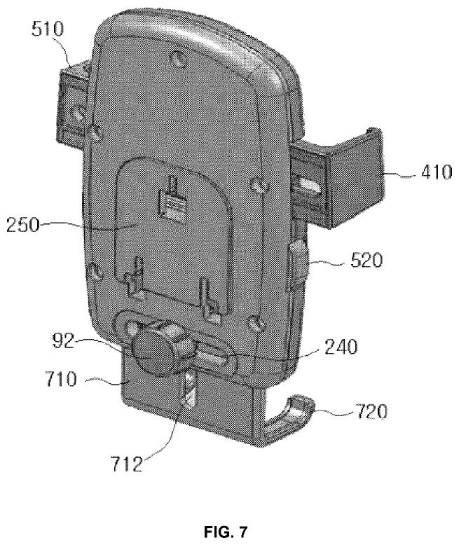

FIG. 7 is a perspective view illustrating the rear surface of the holder to which the bracket 70 is coupled. Referring to FIG. 6, the width of the hole 240 is decided by considering the diameter of the screw portion of the knob 92, and the length of the hole 240 is set in such a designated range that the bracket 70 may move left and right. Furthermore, the bracket 70 includes an up and down moving unit 710 and a support unit 720. The up and down moving unit 710 is pushed to and protruded from the inside of the main body 30, and the support unit 720 has an opening 722 formed in the center thereof. In order for the bracket 70 to move up and down inside the main body 30, the up and down moving unit 710 has a movement hole 712 formed by considering the diameter of the screw portion of the knob 92.

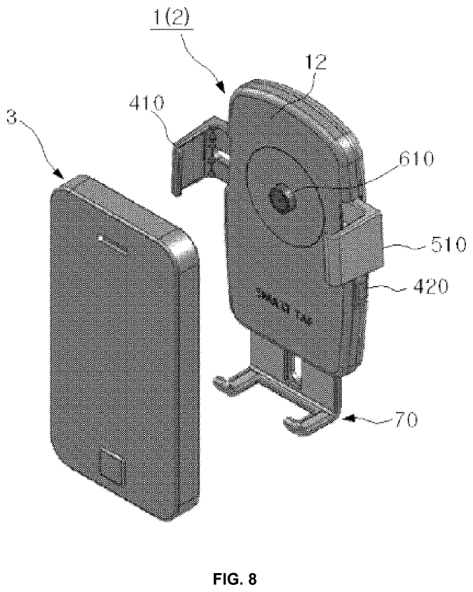

FIG. 8 provides a diagram for explaining a mechanism for holding and releasing a portable device using the holder according to the holders 1, 2 or 2a.

First, in a state where there is no portable device is held on a portable device holders 1 or 2, the first switch 610 is protruded to the outside of the front surface portion 12, and the other sides of the first and second arm moving shafts 430 and 530 are closely attached to both sides of the pressurization plate 612 so as to compress the first and second elastic members 460 and 560. Accordingly, the first and second arms 410 and 510 are protruded to the outside of the main body, and the first and second buttons 420 and 520 are pushed to the inside of the main body.

When the portable device 3 is to be fixed to the holder 1 or 2, the portable device 3 is closely attached to the front surface portion 12 in the front surface side of the holder 1 or 2 as illustrated in FIG. 8. Then, the first switch 610 is pressurized, and the pressurization plate 612 compresses the third elastic member 620. Accordingly, the first and second elastic members 460 and 560 are restored to move the first and second arm moving shafts 430 and 530 to the inside of the main body, and the distance between the first and second arms 410 and 510 is decreased to fix the portable device 4 on the holder 1 or 2. Simultaneously, the first and second button moving shafts 440 and 540 are moved to protrude the first and second buttons 420 and 530 to the outside of the main body.

When the portable device 3 is to be detached from the holder 1 or 2, the first and second buttons 420 and 520 are pushed to the inside of the main body. Then, while the first and second elastic members 460 and 560 are compressed, the distance between the first and second arm moving shafts 430 and 530, that is, the distance between the first and second arms 410 and 510 is increased, and the first switch 610 is protruded by the restoring force of the third elastic member 620.

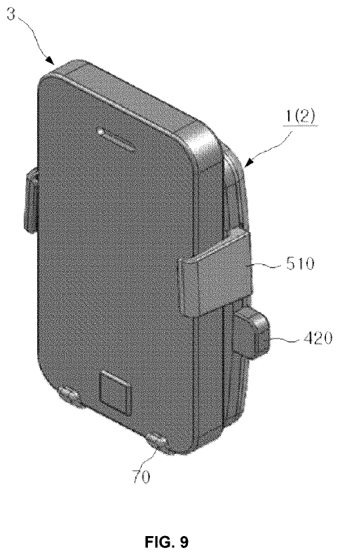

Meanwhile, before the portable device 3 is held as illustrated in FIGS. 8 and 9, the bracket 70 may be moved downward from the main body to sufficiently secure a space for holding the portable device 3. After the portable device 3 is fixed by the first and second arms 410 and 510, the bracket 70 may be moved upward, and the knob 92 may be tightened to further stably maintain the fixed state of the portable device 3. Furthermore, since a cable for connecting the portable device 3 to an external device may be passed through the opening 722 of the bracket 70, the portable device 3 and the external device may be stably connected to each other through the external connection cable without physical stress.

As such, potable devices having various widths may be held by the first and second arms 410 and 510, and stably fixed by the bracket 70. Furthermore, since the bracket 70 is formed to move left and right and/or up and down, various types of portable devices may be held regardless of the lengths of the portable devices.

Therefore, when a portable device was replaced, a holder for a new portable device is not needed separately. Accordingly, the holder according to the embodiment of the present disclosure has an advantage in cost and resource saving.

In another embodiment of the present disclosure, the rear cover 20 may further include a coupling unit 250 formed on the rear surface portion thereof. Through the coupling unit 250, the holder 1 or 2 according to the embodiment of the present disclosure may be coupled to an adhesion-type holder (not illustrated). Accordingly, when the adhesion-type holder is fixed to a dashboard or front window of a vehicle and a portable device is mounted on the holder 1 or 2, the portable device may be freely used while driving.

According to the embodiment of the present disclosure, a portable device may be stably mounted on the holder only by a simple operation of contacting the portable device with a holding surface.

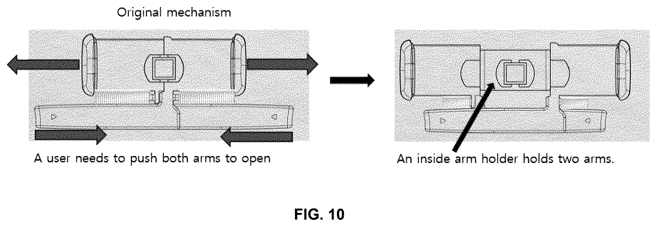

FIG. 10 illustrates a mechanism of a portable device holder to open both arms by pushing both buttons. The portable device mounted on the holder may be released by a simple operation of pressing the buttons at both sides of the holder. Therefore, it is possible to stably mount or release the portable device, without performing a troublesome manipulation or applying a physical force.

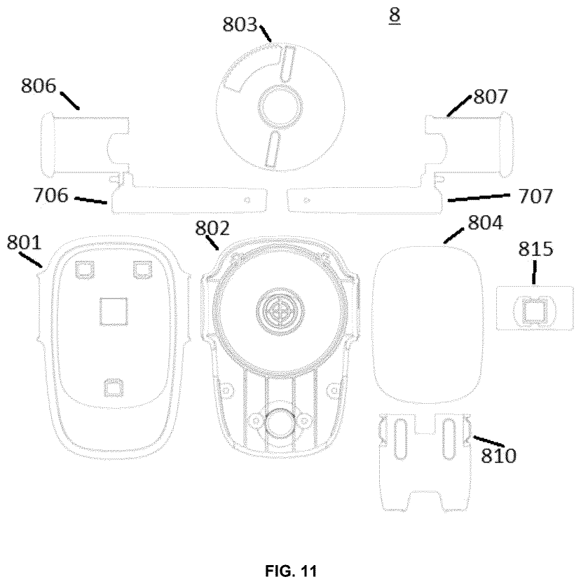

FIG. 11 is an exploded view of another example of a portable device holder of the present disclosure, wherein the first and second switch 420 and 520 are further connected to a disk (3).

According to an embodiment of the present disclosure, a holder (1) for a portable device comprises:
a main body (30) for holding a portable device received on a front surface portion (12) thereof;
a first switch (610) formed at a designated position of the front surface portion of the main body so as to be push into and protruded from the front surface portion;
a first and a second arm (410, 510) formed at left and right sides of the surface portion (12) of the main body (30) whose distance is controlled by the first switch (610) to hold or release the portable device; and
a second switch comprising:
a first button (420) to be physically connected to the first arm (410) inside the main body;
a second button (520) to be physically connected to the second arm (510) inside the main body (30), and varying the distance between the first and second arms (410, 510); and
a disk connected to the first and the second arms and the first and the second buttons,
wherein pushing the first button or the second button moves the first and the second arm to release the portable device.

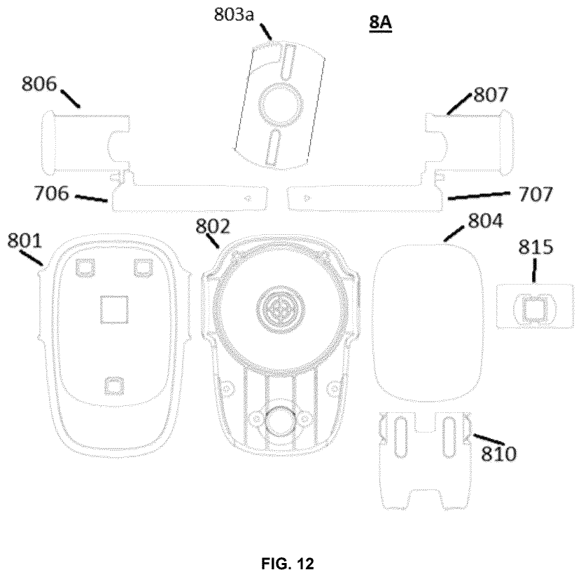

Referring to FIG. 11, the holder 8 according to the embodiment of the present disclosure and FIG. 12 provides a perspective exploded view of the portable device holder of the present disclosure.

The holder 8 of the present disclosure includes a front cover 801 and a rear cover 802, a disk 803 or a rotating part 803a, a button 804, a second switch 805, a left arm 806, a right arm 807, a left button and a right button 706 and 707, and a foot 810, wherein the second switch 805 is connected to the button 804 through a hole 811 in the middle of the front cover 801.

When a portable device is to be fixed to the holder 8, the portable device is closely attached to the front surface to pressurize the button 804, which pushes the second switch 805 to move the disk 803 or the rotating part 803a, to move the left arm 806 and the right arm 807 closer to each other by triggering movement of the disk 803 or the rotating part 803a, wherein the disk 803 or the rotating part 803a is connected to the left and right arms 806 and 807, or when one or both left and right buttons 706 and 707 are pushed to trigger to increase the distance between the left and the right arms 806 and 807.

Referring to FIG. 12, the front cover 801 includes a button 804 connected to a second switch 805 through a hole formed in the middle of the front cover 801.

The back cover 802 includes a hole to provide a position for a cable holder 816 to be located at the lower part of the rear cover 802. Furthermore, the holder 8 contains a disk 803 or a rotating part 803a between the front and back covers 801 and 802 to be anchored by the left and the right arms 806 and 807 and the left and right buttons 706 and 707, so when one or both of the left or the right buttons are pushed, the disk 803 or the rotating part 803a or a rotating part 803a will rotate to push the I and/or right arms 806 and 807 away from the holder 8. Furthermore, the rear cover 802 includes an anchoring hole to connect a mounting bracket 815 and a hole 812 on a lower part of the back for the cable holder 816.

The disk 803 or the rotating part 803a is connected to the left and right arms 806 and 807 and the left and right buttons 706 and 707 via a left arm spring 813 and a fight arm spring 814.

The holder 8 optionally includes a foot 810 containing a left foot pad 817 and a right foot pad 818 that can be moved up and down by pulling down or pushing up to adjust the available space for a mobile device attached on the front surface.

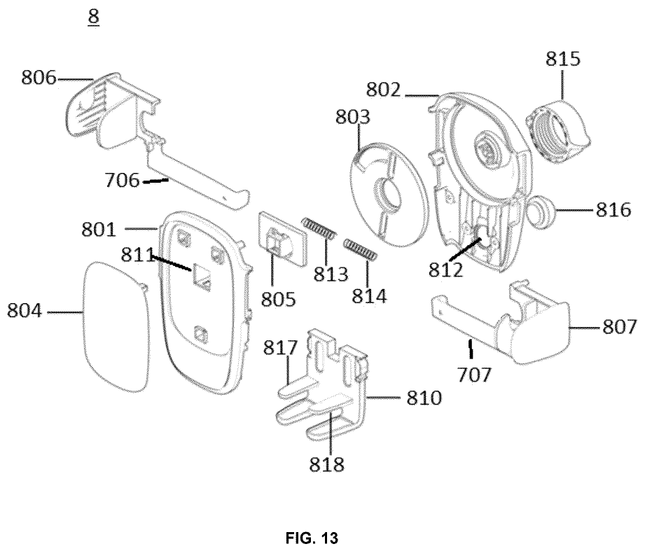

FIG. 13 provides a mechanism of a portable device holder of the present disclosure, wherein how the left and right arms 806 and 807 are connected and operated with the left and right buttons 706 and 707 via the disk 803 or the rotating part 803a.

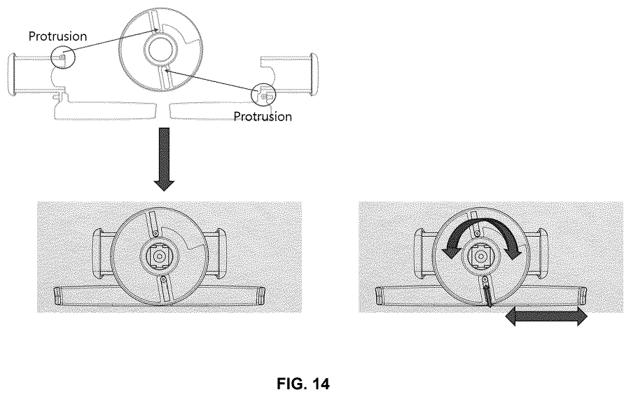

FIG. 14 further provides a mechanism wherein a user can open the left and the right arms 806 and 807 with pushing the left or the right button 706 or 707 to trigger the disk to rotate, wherein two disk holes push out pins to outward to open both arms. All steps are conducted in one step. Compared to the conventional holder where both buttons need to be pushed to release the portable device, the holder of the present disclosure with a disk 803 or a rotating part 803a would require less force to release the portable device. It would be more convenient for a user to use portable device while performing other functions.

The disk 803 or the rotating part 803a is positioned within a cylindrical structure formed when the front cover and back cover are combined. This structure serves as the axis that enables the disk to perform rotational motion. Protrusions formed on the left and right arms are connected to two linear holes created in the disk. When the arms move left and right, the protrusions connected to the disk move within the two holes, allowing the disk to perform rotational motion.

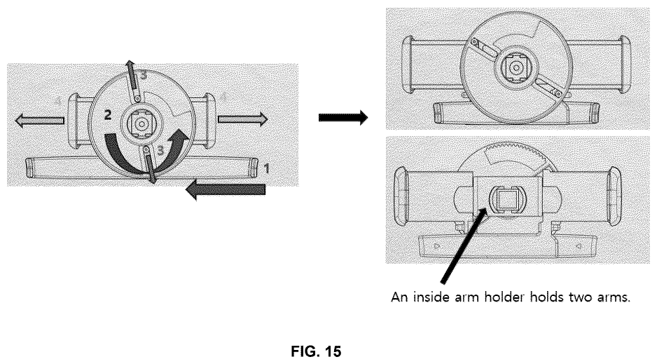

FIG. 15 provides the mechanism for closing both arms of the holder in the present disclosure from the top view. A user can close arms by pushing the button which trigger the inside arm holder to close two arms.

### REFERENCE NUMBERS AND DESCRIPTIONS

| Ref No. | Description |
|---|---|
| 1 | Holder |
| 2 | Holder |
| 3 | Portable device |
| 8 | Holder |
| 10 | Front cover |
| 12 | Surface portion |
| 20 | Rear cover |
| 30 | Main body |
| 40 | First attach/detach control unit |
| 50 | Second attach/detach control unit |
| 60 | Switching unit |
| 70 | Bracket |
| 80 | Screws |
| 92 | Knob |
| 94 | Nut |
| 110 | Switch through-hole |
| 120 | Coupling protrusions |
| 210 | Housing unit |
| 212 | Upper housing unit |
| 214 | Lower housing unit |
| 220a | Coupling grooves |
| 220b | Coupling grooves |
| 220c | Coupling grooves |
| 220d | Coupling grooves |
| 220e | Coupling grooves |
| 240 | Hole |
| 250 | Coupling unit |
| 410 | First arm |
| 420 | First button |
| 430 | First arm moving shaft |
| 432 | Switch coupling grooves |
| 440 | First button moving shaft |
| 450 | First elastic shaft |
| 460 | First elastic members |
| 510 | Second arm |
| 520 | Second button |
| 530 | Second arm moving shaft |
| 532 | Switch coupling grooves |
| 540 | Second button moving shaft |
| 560 | Second elastic members |
| 610 | First swich |
| 612 | Pressurization plate |
| 620 | Third elastic member |
| 706 | Left button |
| 707 | Right button |
| 710 | Up and down moving unit |
| 712 | Movement hole |
| 720 | Support unit |
| 801 | Front cover |
| 802 | Back cover |
| 803 | Disk |
| 803a | Rorating part |
| 804 | Button |
| 805 | Trigger button |
| 806 | Left arm |
| 807 | Right arm |
| 808 | Left arm pad |
| 809 | Right arm pad |
| 810 | Foot |
| 811 | button through-hole |
| 812 | Knob through hole |
| 813 | Left arm Spring |
| 814 | Right arm Spring |
| 815 | Mounting bracket |
| 816 | Cable holder |
| 817 | Left Foot pad |
| 818 | Right Foot pad |

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A holder for a portable device comprises:
a main body for holding a portable device received on a front surface portion thereof;
a first switch formed at a designated position of the front surface portion of the main body so as to be push into and protruded from the front surface portion;
a first and a second arm formed at left and right sides of the surface portion of the main body whose distance is controlled by the first or second switch to hold or release the portable device; and
a second switch comprising:
a first button to be physically connected to the first arm inside the main body;
a second button to be physically connected to the second arm inside the main body, and varying the distance between the first and second arms; and
a disk or a rotating part connected to the first and the second arms and the first and the second buttons,
wherein pushing the first button or the second button moves the first and the second arm to release the portable device.

2. The holder according to claim 1, wherein the first or the second switch comprises a push switch.

3. The holder according to claim 2, wherein the first and second arms are moved toward the inside of the main body by a push operation of the first switch.

4. The holder according to claim 1, wherein the first and second buttons respectively comprise a push switch.

5. The holder according to claim 4, wherein the first and second arms are moved toward the outside of the main body by manipulating the first or second buttons.

6. The holder according to claim 1, the bracket formed at the bottom of the main body so as to support the portable device.

7. The holder according to claim 6, wherein the bracket is fixed to a rear surface portion of the main body by the knob, and formed to move left and right depending on a fixed state of the knob.

8. The holder according to claim 7, wherein the bracket is formed to move up and down depending on the fixed state of the knob.
